(19) United States
(12) Patent Application Publication
(10) Pub. No.: US 2004/0056473 A1
(43) Pub. Date: Mar. 25, 2004

(54) Pocket book insert

(76) Inventor: Anne Hardison, Scottsdale, AZ (US)

Correspondence Address: Steven Thrasher, 391 Sandhill Dr., Richardson, TX, 75080, US

(21) Appl. No.: 10/251,711

(22) Filed: Sep. 20, 2002

(51) Int. Cl. B42D 19/00

(52) U.S. Cl. 281/9

(57) ABSTRACT

The invention is a pocket insert for a book or a booklet. The insert typically includes a base sheet, a pocket sheet coupled to the base sheet so as to create at least a first pocket, and a coupling piece attached to at least the base sheet. Accordingly, persons need not be embarrassed or frustrated by fumbling through briefcases, luggage, or purses to have quick access to items commonly needed when using a book or booklet.

### TECHNICAL FIELD

The present invention relates to books and pamphlets, and more particularly the invention relates to inserts that provide features to books and pamphlets.

### STATEMENT OF A PROBLEM ADDRESSED BY THIS INVENTION

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art.

Discussion

Often, when reading a book (and particularly when traveling), a person will fumble about luggage, purse, or briefcase for pens, post-it notes, and other small items to underline passages, make margin notes, or perform some other simple task. As anyone who has done so can attest, such efforts are frustrating, time consuming, and often break the flow of reading or another activity.

In addition, many persons travel with small booklets, such as passports or travel guides. Often, a person needs items that complement the booklet. For example, when carrying a passport, a person may need items such as a second photo identification, immigration papers, or other items. Accordingly, it would be beneficial to provide a device that allows a person to keep small items near or with a booklet or a book.

### SELECTED OVERVIEW OF SELECTED EMBODIMENTS

The present invention achieves technical advantages as a pocket insert for a book or a booklet. The insert typically includes a base sheet, a pocket sheet coupled to the base sheet so as to create at least a first pocket, and a coupling piece attached to at least the base sheet. Alternative embodiments of the invention may provide additional features such as reading lights, calculators, or zipper-type storage means. Accordingly, persons need not be embarrassed or frustrated by fumbling through briefcases, luggage, or purses to have quick access to items commonly needed when using a book or booklet.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1a illustrates a pocket book insert;

FIG. 1b shows an exploded view of a pocket book insert;

FIG. 2a is a pocket book insert having a slit for coupling the insert to a book or pamphlet;

FIG. 2b shows a pocket book insert having a band for coupling the insert to a book or pamphlet;

FIG. 2c provides a pocket book insert having a detachable strip for coupling the insert to a book or pamphlet;

FIG. 3a is an illustration of an alternative embodiment of a insert having a light source; and

FIG. 3b shows an alternative embodiment of the invention adapted for a shopper.

### AN EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for —functioning—” or “step for —functioning—” in the claims section.

Discussion of the Figures

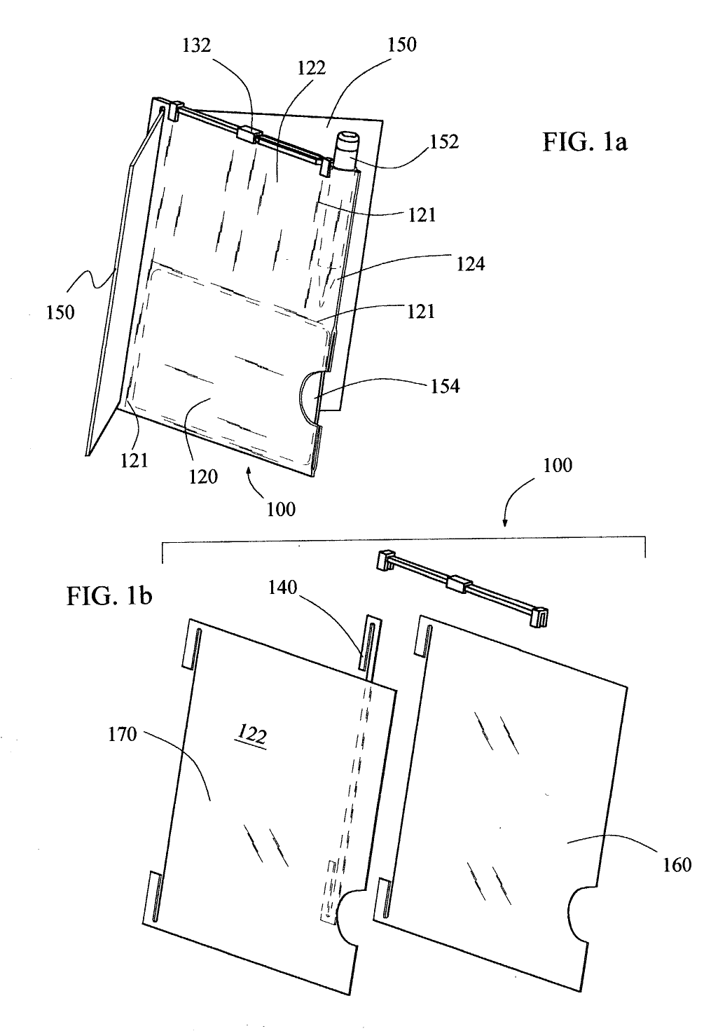

Features and advantages of the invention can be better understood by reviewing FIG. 1a, which illustrates a pocket book insert (the insert) 100 disposed within a booklet 150, and secured about the spine (not shown) of the booklet 150. The insert 100 is shown having a plurality of pockets. A first pocket 120 is adapted to hold a credit card 154, a second pocket 124 is adapted to hold a pencil 124, and a third pocket 122 is adapted to securely close via a pocket fastener such as a zipping-type enclosure 132. Note that the boundaries 121 between the pockets 120, 122, 124 are indicated with dashed lines 121.

The invention can be better understood by examining its components. Accordingly, FIG. 1b shows an exploded view of a pocket book insert 100 that generally includes a base sheet 160, a pocket sheet 170 coupled to the base sheet 160 so as to create at least a first pocket 122, and a coupling piece 140 attached to at least the base sheet, the coupling piece 140 being attachable to at least a portion of a book spine (not shown). The base sheet 160 and the pocket sheet 170 can be coupled together via an adhesive, stitching, or, in the event both the base sheet 160 and the pocket sheet 170 are malleable material, coupling can be achieved with a pressing machine or by the selective application of heat as is known in the art. Of course, although a single base sheet and a single pocket sheet are discussed here, a plurality of base sheets can be coupled together to create storage means for items that provide features to the invention, such as lights as discussed below. In addition, a plurality of pocket sheets may be provided to create pockets on either/both sides of the base sheet. Similarly, multiple base sheets and multiple pocket sheets can be used to create a plurality of pocket inserts coupled to a book spine with a single coupling piece.

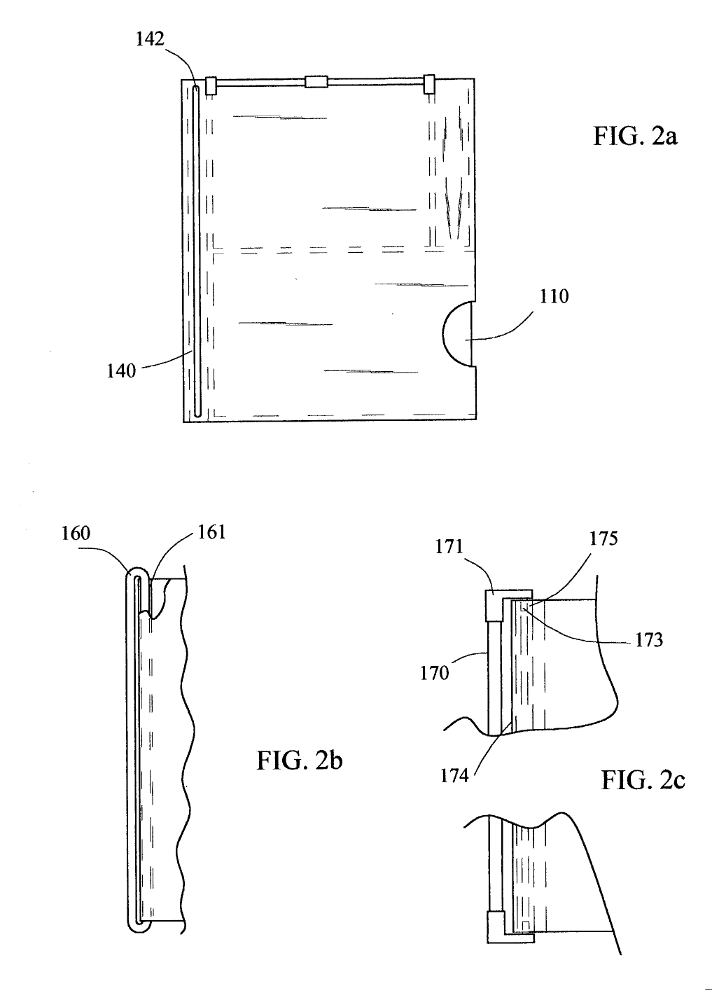

A coupling piece is any means for coupling a book insert to a book spine in a preferred embodiment, the coupling piece is adapted to fit about a spine of a book. In an alternative embodiment, the coupling piece fits about a portion of a book spine, but at least a sufficient portion of the book spine to securely hold the insert in a book. A coupling piece can be made of any material, such as plastic, reinforced plastic, fabric, or cloth, for example, and may be a continuous piece, or may be shaped like a clip or clips that run up and down only a portion of the back of a book spine. For example, FIG. 2a is a pocket book insert having a slit 142 for coupling the insert to a book or pamphlet. The slit 142 of FIG. 2a is preferably created by cutting or burning at least a left-most edge of the base sheet 160. Of course, if the pocket sheet 170 occupies the area of the slit 142, the slit 142 is also created in the pocket sheet 170. In an alternative embodiment of the insert 100, the slit 142 is formed into a flat, sheet-like coupling piece that is attached to at least the base sheet 160, but is preferably attached to the insert by placement and adhesion between the base sheet 160 and the pocket sheet 170.

Likewise, FIG. 2b shows a pocket book insert having a band 160 for coupling the insert to a book or pamphlet, such as a passport. To couple the band 160 to the insert, the band 160 may be a continuous band (continuous meaning that the band is tied or otherwise attached at its ends) that fits within a cavity 161 formed by a small vertical pocket formed between a base sheet and a pocket sheet, or any other combination of other sheets. In an alternative embodiment, the band 160 is coupled to the insert with, for example, an adhesive. Preferably, the band 160 is elastic or plastic. FIG. 2b provides a pocket book insert having a detachable strip 170 for coupling the insert to a book or pamphlet—this is particularly useful for attaching an insert within a thicker book. To couple the insert to a book or pamphlet using the detachable strip 170 having coupling knobs 173, the insert is placed within a book with the coupling edge 174 pressed against an inside edge of a book spine (not shown). Then, the detachable strip 170 is attached to the inset by placing the coupling knobs 173 within a cavity 175 sized to securely accept the coupling knobs 173 (requiring substantial force to remove the coupling knobs 173 from the cavity 175). Of course, any of the above-mentioned coupling pieces may be securely coupled to the insert with an adhesive disposed between a portion of the coupling piece set against the base sheet.

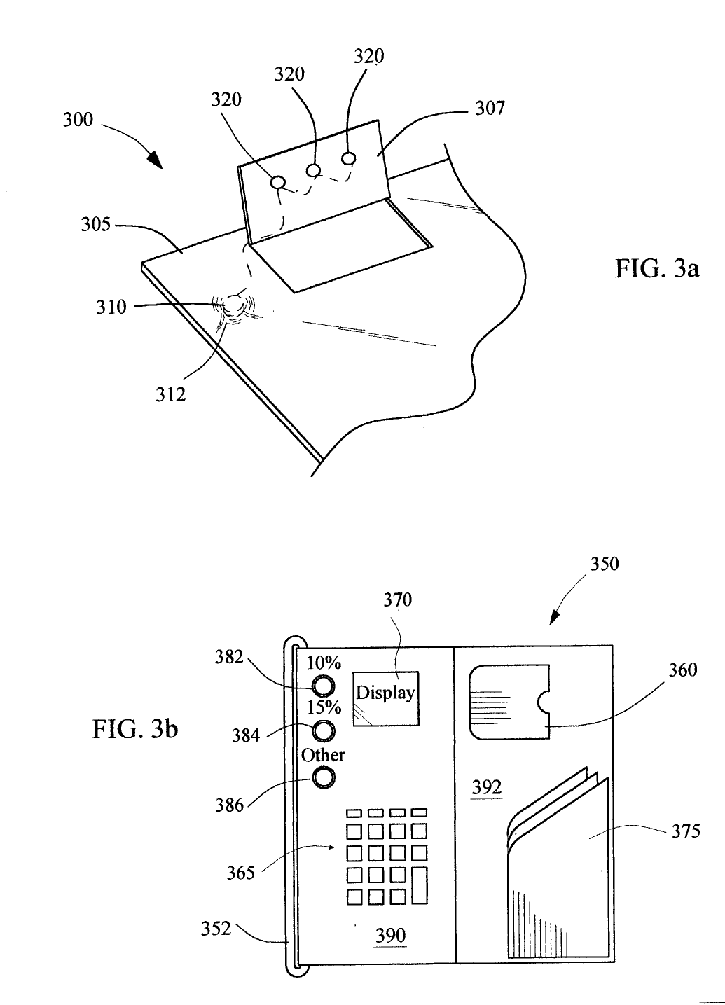

Additional features can be provided to a user by adapting an insert for a specific purpose. For example, persons who read in the dark, such as while traveling on airplanes, may benefit from a reading light. Accordingly, FIG. 3a is an illustration of an alternative embodiment of an insert 300 having a plurality of light sources 320 embodied as light emitting diodes (LEDs) 320. A power source 310 is provided in a first power pocket 312, and powers the LEDs 320 maintained in a flap 307 preferably in a top portion of the pocket sheet 305. Of course, other features can be provided to assist readers, such as a bookmark strip (not shown) which is preferably attached to the base sheet.

FIG. 3b shows an alternative embodiment of an insert adapted for a shopper as a shopper system 300. The shopper system 300 has a credit card pocket 330, at least one coupon pocket 375, and a bill calculator 365 that is preferably disposed underneath a covering on a first panel 390 of the insert 300. A display 370, such as a plasma screen display or liquid crystal display, for example, displays information entered into the calculator 365. Additionally, a plurality of hot buttons 382, 384, and 386 provide a user quick access to frequently used calculator functions, such as a determination of a tip percentage, a determination of a price with sales taxes added in, or other desired functions. In a preferred embodiment, the hot buttons 382, 384, and 386 are programmable. Also in a preferred embodiment, a second panel 392 is foldable over the first panel 390 so that the insert 350 more easily fits into a pocket book or other half-sized book, and can attach to the book spine via a coupling piece 352.

Thus, though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A pocket insert for a book or a booklet (the insert), comprising:
a base sheet;
a pocket sheet coupled to the base sheet so as to create at least a first pocket; and
a coupling piece attached to at least the base sheet, the coupling piece being attachable to at least a portion of a book spine, the coupling piece for coupling the base sheet to a book spine.

2. The insert of claim 1 further comprising a coupling piece adhesive disposed between the coupling piece and the base sheet.

3. The insert of claim 1 further comprising a power source stored in a first pocket.

4. The insert of claim 3 further comprising a reading light coupled to the power source.

5. The insert of claim 4 wherein light is a light emitting diode.

6. The insert of claim 1 further comprising a first credit card pocket

7. The insert of claim 1 further comprising a second pocket.

8. The insert of claim 1 further comprising a pocket fastener coupled to the first pocket.

9. The insert of claim 1 wherein the coupling piece is a reinforced plastic.

10. The insert of claim 1 wherein the coupling piece is a fabric strip.

11. The insert of claim 1 further comprising a bookmark strip attached to the base sheet.

12. The insert of claim 1 wherein the coupling piece is adapted to fit about a spine of a book.

13. The insert of claim 1 wherein the coupling piece is adapted to fit about a passport.

14. The insert of claim 5 wherein the light emitting diodes are maintained in a flap of the pocket sheet.
